(19) United States
(12) Patent Application Publication
(10) Pub. No.: US 2024/0263743 A1
(43) Pub. Date: Aug. 8, 2024

(54) METHOD AND SYSTEM FOR PRESSURISING GASEOUS HYDROGEN

(71) Applicant: ABSOLUT SYSTEM, SEYSSINET-PARISET (FR)

(72) Inventor: Jerome LACAPERE, ST ETIENNE DE CROSSEY (FR)

(21) Appl. No.: 18/565,103

(22) PCT Filed: Jun. 8, 2022
(86) PCT No.: PCT/FR2022/051088

§ 371 Date: Nov. 29, 2023

(30) Foreign Application Priority Data
Jun. 8, 2021 (FR) FR2106017

(51) Int. Cl. F17C 5/06

(52) U.S. Cl. CPC F17C 5/06; F17C 2203/03; F17C 2205/0142; F17C 2221/012; F17C 2223/0123; F17C 2223/036; F17C 2227/0157; F17C 2227/0353; F17C 2227/0388

(57) ABSTRACT

The invention relates to a method for pressurising gaseous hydrogen comprising the following steps: providing a first tank (1) capable of receiving pressurised gaseous hydrogen, filling the first tank (1) with compressed gaseous hydrogen at a first pressure, cooling the compressed gaseous hydrogen contained in the first tank (1) to a first cryogenic temperature, transferring, by means of pressure equalisation, one portion of the gaseous hydrogen at the first cryogenic temperature from the first tank (1) to at least one second tank (2), sealing the at least one second tank containing the hydrogen transferred from the first tank, increasing the pressure in the second tank by heating the hydrogen present in the second tank to a second temperature higher than the first temperature.

### FIELD OF THE INVENTION

The present invention concerns a method and system for pressurising gaseous hydrogen.

### STATE OF THE ART

A system for storing and distributing gaseous hydrogen for fuel cell vehicles must make it possible to fill tanks to a pressure of 350 or 700 bar or more.

In such a system, liquid hydrogen is typically injected into an expansion tank. Since the walls of the expansion tank are at a temperature higher than that of the liquid hydrogen, said hydrogen vaporises instantly. Therefore, the pressure inside the tank increases rapidly and makes liquid filling difficult.

Such a pressure tank is typically filled from a gaseous hydrogen storage tank, by compressing the gaseous hydrogen with several compression stages, each requiring a gas compressor.

The installation of different pressure levels is complex and expensive.

Another technique is to use a high pressure liquid compressor. Such a compressor, suitable for supporting high intermediate pressures, is also a complex and expensive component.

### DISCLOSURE OF THE INVENTION

One aim of the invention is to provide a pressurising and cooling method and system for a gaseous hydrogen filling station able to compress gaseous hydrogen to pressures greater than 200 bar from a gaseous hydrogen tank.

To this end, the invention proposes a method for pressurising gaseous hydrogen comprising the following steps:
providing a first tank capable of receiving pressurised gaseous hydrogen;
filling the first tank (1) with gaseous hydrogen compressed to a first pressure;
cooling the compressed gaseous hydrogen contained in the first tank (1) to a first cryogenic temperature;
transferring by means of pressure equalisation a portion of the gaseous hydrogen at said first cryogenic temperature from said first tank (1) to at least one second tank (2);
hermetically closing the at least one second tank containing the hydrogen transferred from the first tank;
increasing the pressure in the second tank by heating the hydrogen present in the second tank to a second temperature higher than the first temperature.

The system does not use liquid hydrogen.

In some embodiments, the gaseous hydrogen is cooled to the first temperature in the first tank. Preferably, the first tank is cooled by a cryogenic fluid. The cryogenic fluid is liquid nitrogen or liquid methane or liquefied natural gas.

In other embodiments, the gaseous hydrogen is cooled to the first temperature by a heat exchanger arranged upstream of the first tank. In these embodiments, the first tank comprises thermal insulation.

Preferably, the maximum pressure in the first tank is comprised between 500 and 600 bar. The maximum pressure in at least one second tank is comprised between 1000 and 1500 bar.

Advantageously, at least one second tank has a volume less than the volume of the first tank. Particularly advantageously, the volume of the at least one second tank is comprised between 40% and 60% of the volume of the first tank.

Advantageously, the second temperature is comprised between −40° ° C. and 25° C. In some embodiments, the gaseous hydrogen pressurisation method comprises a heating step in at least one second tank.

In some embodiments, a second tank is a tank of a vehicle.

The invention also relates to a system for pressurising hydrogen comprising:
a first tank adapted to receive pressurised gaseous hydrogen;
a cooling device capable of cooling the gaseous hydrogen to a first cryogenic temperature;
a gas compressor adapted to compress gaseous hydrogen upstream of said first tank;
a fluid connection adapted to selectively establish a fluid link between the first tank and a second tank so as to transfer pressurised gaseous hydrogen at the first cryogenic temperature from the first tank to the second tank by equalising the pressure, said second tank being able to be hermetically closed and to be at a second temperature higher than the first temperature of the first tank.

In some embodiments, the first tank is immersed in the cryogenic fluid at the first temperature.

In other embodiments, the first tank comprises conduits able to contain the cryogenic fluid so as to cool the first tank to the first temperature. Preferably, the system comprises a thermal insulator arranged outside the conduits.

In other embodiments, the cooling device is a heat exchanger arranged upstream of the first tank.

Advantageously, the at least one second tank comprises a heating device. Particularly advantageously, the heating device comprises conduits arranged for the circulation of a gas at a temperature greater than or equal to the second temperature. Preferably, the gas is nitrogen or helium.

Advantageously, the at least one second tank further comprises a thermal insulation device.

The invention also relates to a station for filling vehicles with gaseous hydrogen, comprising a system for pressurising hydrogen, the at least one second tank being a tank of a vehicle to be filled with gaseous hydrogen.

### BRIEF DESCRIPTION OF THE FIGURES

Other characteristics and advantages of the invention will result from the detailed description which follows, with reference to the attached drawings, wherein:

FIG. 1 is a diagram of the first part of the pressurisation system.

FIG. 2 is a diagram of another embodiment of the first part of the pressurisation system.

FIG. 3 is a diagram of an embodiment of the second part of the pressurisation system.

FIG. 4 is a diagram of a second embodiment of the second part of the pressurisation system.

FIG. 5 is a diagram of a third embodiment of the second part of the pressurisation system.

### DETAILED DESCRIPTION OF EMBODIMENTS

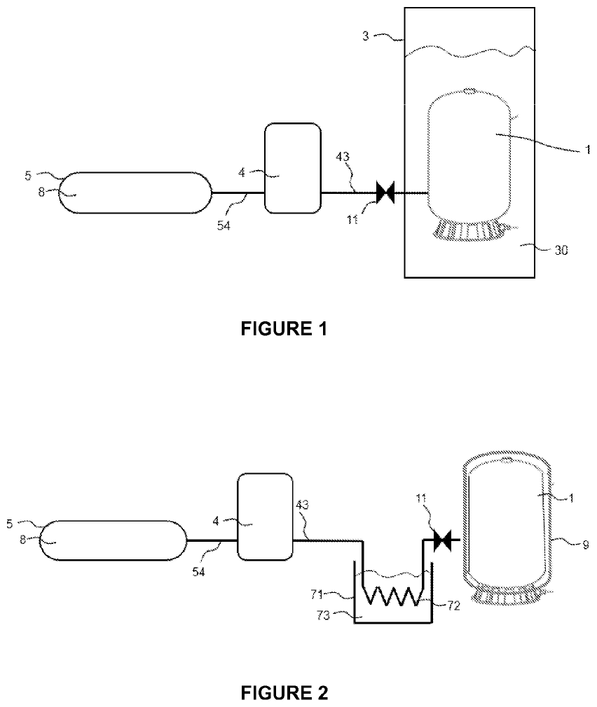

FIG. 1 illustrates an embodiment of a first part of a system for pressurising gaseous hydrogen according to the invention.

Such a system comprises a first tank 1 having a first volume, adapted to receive pressurised gaseous hydrogen. The system further comprises a cooling device capable of cooling the gaseous hydrogen comprised in said first tank 1 to a first temperature which is typically comprised between 75 K and 115 K. Advantageously, the first tank 1 cooled by a cryogenic fluid 30 which is, for example, liquid nitrogen or liquid methane or liquefied natural gas.

In some embodiments, the first tank is immersed in the cryogenic fluid 30 at the first temperature in a cryostat 3.

Alternatively, the first tank 1 comprises conduits able to contain the cryogenic fluid so as to cool the first tank 1 to the first temperature. Said first tank 1 may comprise thermal insulation arranged outside the conduits or the cryostat.

According to other embodiments, with reference to FIG. 2, the cooling device is a heat exchanger 72 arranged upstream of the first tank. Said heat exchanger 72 is in thermal exchange with a cryogenic liquid 73 in a cryostat 71. Preferably, the heat exchanger is immersed in the cryogenic liquid 73. Said cryogenic liquid is, for example, liquid nitrogen or liquid methane or liquefied natural gas.

In some embodiments, the first tank 1 comprises thermal insulation 9 able to thermally insulate the first tank 1 and/or the cooling device.

The system for pressurising gaseous hydrogen further comprises a gas compressor 4 adapted to compress gaseous hydrogen in said first tank from a source of gaseous hydrogen. Said source of gaseous hydrogen is typically a storage tank 5 comprising gaseous hydrogen 8 under a pressure which is typically between 20 and 200 bar. Alternatively, the source of gaseous hydrogen is an electrolyser, the hydrogen being able to be at a pressure comprised between 20 and 50 bar. The gaseous hydrogen 8 is at a second temperature higher than the first temperature. Typically, the second temperature is close to ambient temperature which is around 230 K-330 K.

The system further comprises conduits 54, 43 arranged to establish a fluid connection between the source of gaseous hydrogen 5, the gas compressor 4 and the first tank 1 so as to transfer pressurised gaseous hydrogen from the source of gaseous hydrogen to the first tank 1. The system comprises at least one valve 11 capable of hermetically closing the tank 1.

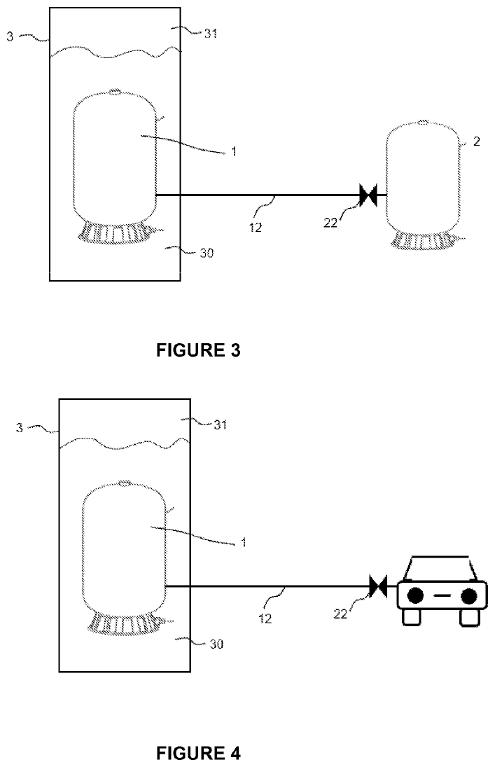

With reference to FIG. 3, the system for pressurising gaseous hydrogen further comprises a second tank 2 having a third temperature higher than the first temperature. The third temperature is typically comprised between 230 K and 330 K. In some embodiments, the third temperature is identical to the second temperature.

The second tank 2 may have a heating device. By way of illustration and non-limiting, said heating device may comprise conduits arranged for the circulation of a gas at a temperature greater than or equal to the second temperature. Preferably, said gas is nitrogen or helium. When the second tank 2 comprises a heating device, said second tank 2 advantageously comprises thermal insulation capable of maintaining the hydrogen present in said second tank 2 at the third temperature.

Advantageously, said second tank 2 has a second volume less than the first volume of the first tank 1. According to an illustrative and non-limiting example, the volume of the second tank 2 can be comprised between 40% and 60% of the volume of the first tank 1.

The system further comprises a conduit 12 arranged to establish a fluid connection between the first tank 1 and the second tank 2 so as to transfer pressurised gaseous hydrogen from the first tank 1 to the second tank 2 by equalising the pressure, and a valve 22 arranged to hermetically close said second tank 2.

Such a system can be used in a gaseous hydrogen vehicle filling station.

In one embodiment, with reference to FIG. 4, the second tank 2 is a tank of a vehicle to be filled with gaseous hydrogen.

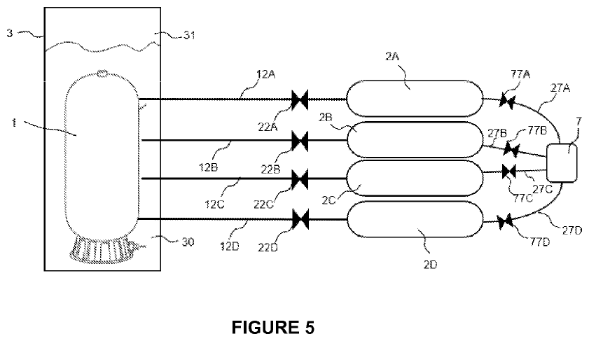

In some embodiments, with reference to FIG. 5, additional tanks are added to achieve several compression stages. In this case, the system comprises several second tanks 2A, 2B, 2C, 2D. The number of second tanks is indicated for purely illustrative and non-limiting purposes. The number of second tanks 2A, 2B, 2C, 2D is typically between 2 and 5 and can be higher in certain embodiments.

The number of second tanks 2A-2D depends on the capacity of the tanks, the space available, and the use cycle of the pressurisation system, in particular the quantity of hydrogen to be distributed and the number of daily fillings, the maximum pressures of the tanks to be filled (350 or 700 bar or another pressure), the choice of the maximum admissible pressures in the second tanks 2A-2D and the effective pressure remaining in the tanks to be filled.

The volume of each second tank 2A, 2B, 2C, 2D is preferably less than the volume of the first tank 1 but can be identical. Alternatively, at least two tanks can have a different volume from each other.

The system further comprises a conduit 12A, 12B, 12C, 12D, arranged to establish a fluid connection between the first tank 1 and the respective second tank 2A-2D, so as to transfer pressurised gaseous hydrogen from the first tank 1 to the second tank 2 by equalising the pressure, and a valve 22A, 22B, 22C, 22D arranged to hermetically close the respective second tank 2A-2D.

The tanks 2A-2D each have a third temperature higher than the first temperature. The third temperature is typically between 230 K and 330 K. The third temperature may be identical to the second temperature. In some embodiments, the third temperature of each tank 2A-2D is identical. Alternatively, at least two tanks 2A-2D may have a different temperature.

Each second tank 2A-2D may comprise a heating device. By way of illustration and non-limiting, said heating devices may comprise conduits arranged for the circulation of a gas at a temperature greater than or equal to the second temperature. Preferably, said gas is nitrogen or helium. When at least one second tank 2A-2D comprises a heating device, the respective second tank 2A-2D advantageously comprises thermal insulation capable of maintaining the hydrogen present in said second tank 2A-2D at the third temperature. When the system comprises several second tanks 2A-2D, said system further comprises a gas compressor 7 arranged so as to draw off gaseous hydrogen from a tank 2A-2D and compress said gaseous hydrogen in another of the tanks 2A-2D by means of conduits 27A-27D and valves 77A-77D.

We will now describe the method for pressuring hydrogen using a system for pressurising gaseous hydrogen as described above.

The first step consists of transferring gaseous hydrogen 8 from a source of gaseous hydrogen 5 into the first tank 1, by compressing said gaseous hydrogen 8 by means of the gas compressor 4. The gaseous hydrogen is cooled to the first temperature during filling, either inside the first tank 1, or by means of a cooling device arranged upstream of the first tank 1. At the end of said first step, the first tank 1 is filled with gaseous hydrogen at the first temperature to a first pressure which is typically between 500 and 600 bar.

When the filling is completed, the valve 11 is closed in order to cut the fluid connection between the source of liquid hydrogen and to hermetically close the first tank 1.

Subsequently, valve 22 is opened and part of the gaseous hydrogen is transferred from said first tank 1 to the second tank 2 by pressure equalisation. During this step, the transferred gaseous hydrogen is at a temperature close to the first temperature. When the second tank 2 has a volume less than the volume of the first tank 1, the pressure after the transfer step remains high, which makes it possible to increase the efficiency of the pressurisation system.

When the pressures of the first tank 1 and the second tank 2 are equal to an equilibrium pressure, the valve 22 is closed, thus hermetically closing the second tank 2. The gaseous hydrogen transferred into the second tank 2 is heated to the third temperature of the second tank 2. Heating can be carried out by heat exchange with the environment, or by a heating device.

The energy provided by the environment warmer than the gaseous hydrogen makes it possible to auto-pressurise the gaseous hydrogen in the second tank 2. The gaseous hydrogen in the second tank 2 is then at a second pressure which is greater than the first pressure in the first tank 1 and greater than the equilibrium pressure. Said second pressure is typically between 1000 and 1500 bar.

The pressurised gaseous hydrogen in the second tank 2 can then be used for filling one or more fuel cell vehicles (the tank 2 can itself be a vehicle tank) or for other applications.

In the case where the second tank 2 is the tank of a vehicle, the second pressure is typically 700 bar according to the current standards. The hydrogen can then be used directly in the vehicle. Higher pressure values can be obtained and implemented if the standards concerning fuel cell vehicles change.

In the case where the system comprises several second tanks 2A, 2B, 2C, 2D, each second tank 2A-2D is filled from the first tank as described above.

The pressurised gas in the second tanks 2A-2D can then be used to supply a pressurised gaseous hydrogen application. The gas is supplied by successively equalising the pressure between one or more of the tanks 2A-2D and the tank of the application to be filled.

The second tank 2A-2D with the lowest pressure is used first. When the equilibrium pressure between said second tank 2A-2D having the lowest pressure and the vehicle tank is reached, filling is continued from the second tank 2A-2D having the lowest pressure greater than said equilibrium pressure. Thus, the filling pressure is gradually increased and the first tank 2A-2D with the highest hydrogen pressure is used last.

After distributing the gaseous hydrogen, the second tank 2A-2D having the lowest pressure will be used for a new filling of cold gaseous hydrogen from the first tank 1. Thus the second tanks 2A-2D are filled in turn, when they reach a pressure too low to be able to be used for distributing gaseous hydrogen.

When a tank has a pressure too low for gas distribution use but too high to be filled with cooled gaseous hydrogen from the first tank 1, the gas compressor 7 is used to lower the pressure of said tank and transfer the vapour to a higher pressure tank. When the pressure becomes lower than the pressure of the first tank 1 containing the cold gaseous hydrogen, the transfer of said cold gaseous hydrogen can be carried out as in filling.

Thus the tanks 2A-2D are filled in turn, when they reach a low pressure so that they can be used for distributing gaseous hydrogen.

1. A method for pressurising gaseous hydrogen comprising:
providing a first tank capable of receiving pressurised gaseous hydrogen;
filling the first tank with gaseous hydrogen compressed to a first pressure;
cooling the compressed gaseous hydrogen contained in the first tank to a first cryogenic temperature;
transferring by means of pressure equalization a portion of the gaseous hydrogen at said first cryogenic temperature from said first tank to at least one second tank;
hermetically closing the at least one second tank containing the hydrogen transferred from the first tank;
increasing the pressure in the second tank by heating the hydrogen present in the second tank to a second temperature higher than the first temperature.

2. The method according to claim 1, wherein the gaseous hydrogen is cooled to the first cryogenic temperature in the first tank.

3. The method according to claim 2, wherein the first tank is cooled by a cryogenic fluid.

4. The method according to claim 3, wherein the cryogenic fluid is liquid nitrogen or liquid methane or liquefied natural gas.

5. The method according to claim 1, wherein the gaseous hydrogen is cooled to the first cryogenic temperature by a heat exchanger arranged upstream of the first tank.

6. The method according to claim 5, wherein the first tank comprises a thermal insulation.

7. The method according to claim 1, wherein a maximum pressure in the first tank is comprised between 500 and 600 bar.

8. The method according to claim 1, wherein a maximum pressure in at the least one second tank is comprised between 1000 and 1500 bar.

9. The method according to claim 1, wherein the at least one second tank has a volume less than a volume of the first tank.

10. The method according to claim 9, wherein the volume of the at least one second tank is comprised between 40% and 60% of the volume of the first tank.

11. The method according to claim 1, wherein the second temperature is comprised between −40° C. and 25° C.

12. The method according to claim 1, comprising a heating step in the at least one second tank.

13. The method according to claim 1, wherein the at least one second tank is a tank of a vehicle.

14. A system for pressurising hydrogen comprising
a first tank adapted to receive pressurized gaseous hydrogen;
a cooling device capable of cooling the gaseous hydrogen to a first cryogenic temperature;
a gas compressor configured to compress gaseous hydrogen upstream of said first tank, and
a fluid connection configured to selectively establish a fluid link between the first tank and at least one second tank so as to transfer pressurised gaseous hydrogen at the first cryogenic temperature from the first tank to the at least one second tank by equalizing the pressure, said at least one second tank being able to be hermetically closed and to be at a second temperature higher than the first temperature of the first tank.

15. The system according to claim 14, wherein the first tank is immersed in a cryogenic fluid at the first temperature.

16. The system according to claim 14, wherein the first tank comprises conduits able to contain a cryogenic fluid so as to cool the first tank to the first temperature.

17. The system according to claim 16, comprising a thermal insulator arranged outside the conduits.

18. The system according to claim 14, wherein the cooling device is a heat exchanger arranged upstream of the first tank.

19. The system according to claim 14, wherein a second tank comprises a heating device.

20. The system according to claim 19, wherein the heating device comprises conduits arranged for the circulation of a gas at a temperature greater than or equal to the second temperature.

21. The system according to claim 20, wherein the gas is nitrogen or helium.

22. The system according to claim 14, wherein the at least one second tank also comprises a thermal insulation device.

23. A station for filling vehicles with gaseous hydrogen, comprising a system according to claim 14, the at least one second tank being a tank of a vehicle to be filled with gaseous hydrogen.
